(19) United States
(12) Patent Application Publication
(10) Pub. No.: US 2014/0331610 A1
(43) Pub. Date: Nov. 13, 2014

(54) METHOD AND APPARATUS FOR DISPOSAL OF A PHARMACEUTICAL PRODUCT BLISTER CARD

(71) Applicant: Mallinckrodt LLC, Hazelwood, MO (US)

(72) Inventors: Robert J. Ziemba, Cincinnati, OH (US); Vernon D. Ortenzi, Burlington, KY (US)

(21) Appl. No.: 14/336,357

(22) Filed: Jul. 21, 2014

Related U.S. Application Data
(63) Continuation of application No. 13/103,266, filed on May 9, 2011.
(60) Provisional application No. 61/333,107, filed on May 10, 2010.

(51) Int. Cl. B09B 3/00; B65B 53/02

(52) U.S. Cl. CPC B09B 3/0075; B65B 53/02
USPC 53/442

(57) ABSTRACT

A pharmaceutical product supply including primary packaging (e.g., a blister card) having a plurality of receptacles and pharmaceutical product (e.g., one or more pills, capsules, etc.) enclosed within at least one of the receptacles. Heating the pharmaceutical product supply to at least an activation temperature of a heat-activated encapsulation material associated with the supply may encapsulate the pharmaceutical product to reduce the likelihood that the pharmaceutical product can thereafter be administered, and thereby facilitates disposal of the pharmaceutical product. In one embodiment, a tray of a primary packaging is constructed of the heat-activated encapsulation material. In another embodiment, primary packaging may be disposed within a cavity of secondary packaging (e.g., carton), and the heat-activated encapsulation material may be in the form of a layer that is also located within the cavity.

### CROSS-REFERENCE TO RELATED APPLICATIONS

This patent application is a continuation of pending U.S. patent application Ser. No. 13/103,266, entitled “METHOD AND APPARATUS FOR DISPOSAL OF A PHARMACEUTICAL PRODUCT BLISTER CARD,” and filed on May 9, 2011, which is a non-provisional patent application of and claims priority to U.S. Provisional Patent Application Ser. No. 61/333,107, entitled “METHOD AND APPARATUS FOR DISPOSAL OF A PHARMACEUTICAL PRODUCT BLISTER CARD,” and filed on May 10, 2010 (now expired). The entire disclosure of each patent application set forth in this “CROSS-REFERENCE TO RELATED APPLICATIONS” section is hereby incorporated by reference.

### FIELD OF THE INVENTION

The present invention generally relates to the field of packaging for pharmaceutical products such as pills, capsules, and the like and, more particularly, to packaging arrangements that facilitate the disposal of pharmaceutical products (e.g., to reduce the potential of illicit usage of unused pharmaceutical product).

### BACKGROUND

Abuse, misuse, and overdose of pharmaceutical products (e.g., pain management drugs) are serious health concerns that affect many people on a daily basis all over the world. For instance, diversion and subsequent misuse or abuse may occur when a patient gets a prescription for a pharmaceutical product and does not use all of the pharmaceutical product for whatever reason (e.g., a doctor may prescribe a pharmaceutical product for a patient and advise the patient to take the pharmaceutical product on an “as needed” basis; a patient may be advised to use an entire prescribed amount of pharmaceutical product, but may unilaterally decide to discontinue use of the pharmaceutical product as one or more symptoms disappear). In any case, remaining pharmaceutical product may be ultimately acquired by an individual other than for whom the pharmaceutical product was originally prescribed (e.g., transferred by the original patient to another individual, such as family member or friend; stolen). While unused pharmaceutical product may be disposed of in the trash, this may not be viewed by some as a secure method of disposal.

In the case of transdermal analgesic patches, a used patch may still retain a significant amount of active ingredient in the patch. A used patch can be very dangerous and can even lead to death for people who have not been prescribed the patch. While some patch manufacturers recommend flushing used patches down the toilet, this practice has raised concerns about drug product entering the water supply. In some states, “take back” programs have been instituted, allowing users to request shipping materials in order to ship used or unused pharmaceutical product (e.g., patches, pills, capsules) to a certified disposal company. These programs are costly and require several actions by the patient at multiple times.

### SUMMARY

A first aspect of the present invention is embodied by a pharmaceutical product supply including pharmaceutical product packaging having a plurality of receptacles along with a heat-activated encapsulation material that melts at an activation temperature, and pharmaceutical product enclosed within at least one of the plurality of receptacles. Heating the pharmaceutical product packaging to at least the activation temperature melts the heat-activated encapsulation material to at least substantially encapsulate the pharmaceutical product within the pharmaceutical product packaging.

A second aspect of the present invention is embodied by a pharmaceutical product supply having pharmaceutical product packaging including a plurality of receptacles, pharmaceutical product enclosed within at least one of the plurality of receptacles, and a sleeve disposable about the pharmaceutical product packaging and that includes a heat-activated encapsulation material. Heating the pharmaceutical product supply to at least an activation temperature of the heat-activated encapsulation material, and when the pharmaceutical product packaging is disposed in the sleeve, melts the heat-activated encapsulation material to at least substantially encapsulate the pharmaceutical product within the pharmaceutical product packaging.

A third aspect of the present invention is embodied by a pharmaceutical product supply having pharmaceutical product packaging with a plurality of receptacles, pharmaceutical product enclosed within at least one of the plurality of receptacles, and a container including a heat-activated encapsulation material. Heating the pharmaceutical product supply to at least an activation temperature of the heat-activated encapsulation material, and when the pharmaceutical product packaging is disposed in the container, melts the heat-activated encapsulation material to at least substantially encapsulate the pharmaceutical product within the pharmaceutical product packaging.

A fourth aspect of the present invention is embodied by a pharmaceutical product supply having pharmaceutical product packaging with a plurality of receptacles, pharmaceutical product enclosed within at least one of the plurality of receptacles, and a container. The container includes an openable cover, a latching mechanism for the cover, and a heat-activated encapsulation material (e.g., located in proximity to the latching mechanism). Heating the pharmaceutical product supply to at least an activation temperature of the heat-activated encapsulation material, and when the pharmaceutical product packaging is disposed in the container, melts the heat-activated encapsulation material so as to come into contact with the latching mechanism.

A number of feature refinements and additional features are applicable to each of the first through the fourth aspects of the present invention. These feature refinements and additional features may be used individually or in any combination. As such, each of the following features that will be discussed may be, but are not required to be, used with any other feature or combination of features of the first through the fourth aspects. The following discussion is separately applicable to each of the first through the fourth aspects, up to the start of the discussion of a fifth aspect of the present invention.

The pharmaceutical product packaging may be in the form of a blister card. At the time of the original transfer of the blister card to a patient, each of its plurality of receptacles may include pharmaceutical product. Although pharmaceutical product could be contained within each of the plurality of receptacles at the time of activation of the heat-activated encapsulation material (e.g., in preparation for disposal of the blister card), some of the receptacles may be empty at the time of activation of the heat-activated encapsulation material. That is, one or more of the receptacles may contain pharmaceutical product at the time of activation of the heat-activated encapsulation material.

Scoring or perforations could be provided between each adjacent pair of receptacles of the pharmaceutical product packaging when in the form of a blister card or the like. As such, a single “blister pack” could be removed from the remainder of the blister card and for any appropriate reason. Pharmaceutical product packaging in the form of a blister card may include a pre-formed tray or the like having a number of receptacles or pockets. Any appropriate number of receptacles may be incorporated by such a blister card. The various receptacles may be disposed in any appropriate arrangement, for instance in the form of a matrix having a certain number of rows and a certain number of columns at the time the blister card is dispensed to a patient or other end user.

An appropriate covering may be positioned over each receptacle in the above-noted blister card tray to enclose the associated pharmaceutical product. Such a covering may be in the form of a film, a foil, paper, a sheet-like material, or the like. In any case, this covering may be secured to the tray in any appropriate manner to seal pharmaceutical product within each of the various receptacles (e.g., a single pharmaceutical product dose). In one embodiment, this covering is rupturable over each of the individual receptacles of the tray to gain access to the pharmaceutical product within the receptacle. Rupturing the covering that overlies one receptacle should not affect the covering over any of the other receptacles (e.g., pharmaceutical product in these other receptacles should remain enclosed within the tray by the covering). In another embodiment, the covering may be “peeled” away from at least part of the tray to expose pharmaceutical product in at least one receptacle. Although a single covering could be positioned over each of the various receptacles, individual coverings could be positioned over each individual receptacle as well.

In an embodiment, the pharmaceutical product packaging contacts the pharmaceutical product. The pharmaceutical product packaging may be in the form of what is known as “primary packaging”. Primary packaging may be in direct contact with the pharmaceutical product and may be the material that first envelops and holds (e.g., encloses) the pharmaceutical product. For instance, the primary packaging may include a tray (e.g., formed plastic tray) having the plurality of receptacles (e.g., pockets) for receipt of pharmaceutical product (e.g., one or more pills, tablets, capsules), along with a covering (e.g., film, foil, paper) that is sealed to the tray (e.g., over the surface of the tray that includes the plurality of receptacles). In this regard, the primary packaging may be in the form of a blister card or pack. One or more portions of the tray and/or covering may be in direct contact with the pharmaceutical product. In the absence of heating the pharmaceutical product supply to the activation temperature, the covering can either be removed or the pharmaceutical product can be pushed or pressed through the covering to expose or otherwise access the pharmaceutical product. In one variation, the covering (and other features of the pharmaceutical product supply such as an entirety of the pharmaceutical product packaging) may be non-metallic to limit sparking or arcing during heating of the pharmaceutical product supply. Although a single covering could be disposed over each of the plurality of receptacles of a blister pack tray, each receptacle could also have its own individual covering.

In other embodiments, the pharmaceutical product supply may include one or more containers (e.g., boxes, cartons) that store or enclose the pharmaceutical product packaging. The containers may be in the form of what is known as “secondary packaging”. Secondary packaging may be provided to enclose and protect the primary packaging (e.g., to facilitate storage of the pharmaceutical product by a patient; to withstand normal shipping cycles as stated by the manufacturer), and may be constructed of any appropriate material such as cardboard, plastics, or the like. In any event, one or more portions of the pharmaceutical product packaging (e.g., primary packaging) and/or the container (e.g., secondary packaging) may include the heat-activated encapsulation material. In one arrangement, at least one of the tray and the covering of the primary packaging includes the heat-activated encapsulation material. Upon heating the primary packaging to at least the activation temperature of the heat-activated encapsulation material, the heat-activated encapsulation material may first melt and flow and then shrink, congeal, and/or harden about any pharmaceutical product contained within the primary packaging (e.g., after a cooling period) to at least partially or substantially encapsulate the pharmaceutical product and render the primary packaging unopenable. For instance, when the tray is formed of the heat-activated encapsulation material, the portion of the tray forming a respective receptacle may melt and shrink around the pharmaceutical product inside the respective receptacle. In any event and before heating, the primary packaging may be inserted into a container that is not prone to melting or otherwise structurally degrading during the heating process (e.g., because it may have a higher melting or activation temperature than that of the heat-activated encapsulation material). In this regard, the container may serve to contain any of the melted heat-activated encapsulation material.

In another arrangement, the container may include a layer, strip or portion of heat-activated encapsulation material within an interior cavity of the container near or adjacent to where the primary packaging is stored in the interior cavity. Again, heating of the pharmaceutical product supply at least to the activation temperature may render the primary packaging and/or the container unopenable so that access to and/or use of the pharmaceutical product is at least substantially limited. When the pharmaceutical product supply includes a sleeve made at least partially of a heat-activated encapsulation material, both the pharmaceutical product packaging (e.g., the primary packaging) and the sleeve may be stored in a container (e.g., separately) until the time it is desired to encapsulate the pharmaceutical product and/or render the pharmaceutical product at least substantially inaccessible. In one variation, the sleeve can be removed, slid over the pharmaceutical product packaging, inserted back into the interior cavity of the container, and then heated to the activation temperature. In another variation, the sleeve may be an integral part of the interior cavity of the container such that the pharmaceutical product packaging (and pharmaceutical product thereinside) may be simply inserted into the interior cavity of the container.

When a container of the pharmaceutical product supply includes a cover movable between open and closed positions and a latching or locking mechanism for securing the cover in the closed position, the melted heat-activated encapsulation material may be operable to contact the latching mechanism (e.g., both a first latching member connected to a body of the container and a second latching member connected to the cover). In this regard, as the first and second latching members may be unable to separate once the heat-activated encapsulation material has congealed or solidified, the cover may be unopenable in the intended fashion, and any pharmaceutical product inside the container may be thereby inaccessible. Activation of the heat-activated encapsulation material may render the latching mechanism inoperable such that the cover may no longer be moved from a closed position to an open position. In some arrangements, the latching mechanism itself may be constructed of a heat-activated encapsulation material.

The heat-activated encapsulation material may be subject to a number of characterizations. For instance, the heat-activated encapsulation material may be in the form of one or more “encapsulation components” operable to at least partially or fully encase or encapsulate the pharmaceutical product, to fixedly seal the container (e.g., fix or bond a cover to the container), or both, so as to reduce the potential that the pharmaceutical product will thereafter be administered to an individual. Non-limiting examples for the heat-activated encapsulation material include, for instance and without limitation, plastic, wax (e.g., soy wax), adhesive, combinations thereof, and the like which may be in any appropriate form such as layers, sleeves, elements, etc. Use of the phrase “heat-activated encapsulation material” or “encapsulation component” herein also contemplates use of more than a single encapsulation material or component.

In one embodiment, heating the pharmaceutical product supply to at least the activation temperature of the heat-activated encapsulation material activates the heat-activated encapsulation material without melting or at least significantly structurally affecting other aspects of the pharmaceutical product supply (e.g., secondary packaging). “Activating” the heat-activated encapsulation material may include inducing a change in state or phase of the heat-activated encapsulation material. For instance, the ability of the heat-activated encapsulation material to flow may increase by heating the pharmaceutical product supply. The heat-activated encapsulation material may be a solid at room temperature, and in response to the heating of the pharmaceutical product supply, the heat-activated encapsulation material may change to a liquid or liquid-like state or phase. Heating the pharmaceutical product supply may cause the heat-activated encapsulation material to melt. In any case, it should be appreciated that the heat-activated encapsulation material may be chosen so as to not have an adverse effect on the pharmaceutical product prior to its activation.

A fifth aspect of the present invention is embodied by a method of disposing of un-used pharmaceutical product, including the steps of heating any of the pharmaceutical product supplies discussed herein to at least the activation temperature, melting the heat-activated encapsulation material from the heating step, and at least substantially encapsulating the pharmaceutical product after the melting step.

A number of feature refinements and additional features are applicable to the fifth aspect of the present invention. These feature refinements and additional features may be used individually or in any combination. As such, each of the following features that will be discussed may be, but are not required to be, used with any other feature or combination of features of the fifth aspect.

In one arrangement, the encapsulating step may include solidifying the encapsulation material after the melting step by, for instance, allowing the encapsulation material to cool to a temperature below the activation temperature of the heat-activated encapsulation material. The encapsulating and/or solidifying steps may essentially “lock” the pharmaceutical product in the pharmaceutical product packaging. In this regard, the potential for administering the pharmaceutical product to an individual may be reduced as it now may be at least partially encased within a “blob” of plastic or other material making up the heat activated encapsulation material.

In another arrangement, the method may include (e.g., before the heating step) the steps of disposing the pharmaceutical product packaging within a container, and activating a latching mechanism of the container after the disposing step (e.g., closing a cover of the container and engaging first and second latching members of the latching mechanism, the first and second latching members including corresponding latches, tabs, snaps, springs, slots, or the like). In this arrangement, the encapsulating step includes locking (e.g., at least substantially permanently) the latching mechanism (e.g., by having the heat-activated encapsulation material solidify between the first and second latching members) in its locked state or condition. The heating step may include, for instance, positioning the pharmaceutical product supply in a microwave oven, and operating the microwave oven at any appropriate power for any appropriate length of time to achieve at least the activation temperature. However, any appropriate heat source may be utilized. In any event, the pharmaceutical product may at this point be appropriately disposed of (e.g., discarded in a trash receptacle).

A “pharmaceutical product” as used herein may generally define any material or substance used in the course of a medical treatment, medical diagnosis, therapy, or the provision of any other appropriate medical care. A given material need not contain an active drug compound or ingredient to be considered a “pharmaceutical product” for purposes of the present invention.

A pharmaceutical product within the container may be in any appropriate form, in any appropriate dose, and of any appropriate type. A pharmaceutical product encompasses both a single-dose configuration (e.g., a single pill) and a multiple dose configuration (e.g., a plurality of pills). Pharmaceutical product may be in any appropriate form such as (but not limited to) pills, tablets, chewables, capsules, or the like. Further, a “pharmaceutical product” may refer to or include any “drug” as defined in Title 21 of the United States Code, Section 321(g)(1).

Any of the embodiments, arrangements, and the like discussed herein may be used (either alone or in combination with other embodiments, arrangement, and the like) with any of the disclosed aspects. Any feature disclosed herein that is intended to be limited to a “singular” context or the like will be clearly set forth herein by terms such as “only,” “single,” “limited to,” or the like. Merely introducing a feature in accordance with commonly accepted antecedent basis practice does not limit the corresponding feature to the singular (e.g., indicating that secondary packaging (e.g., a container) includes “a cover” alone does not mean that the container includes only a single cover). Moreover, any failure to use phrases such as “at least one” also does not limit the corresponding feature to the singular (e.g., indicating that a container includes “a cover” alone does not mean that the container includes only a single cover). Use of the phrase “at least generally,” “at least substantially,” or the like in relation to a particular feature encompasses the corresponding characteristic and insubstantial variations thereof (e.g., indicating that a structure is at least generally cylindrical encompasses the structure being cylindrical; indicating that a heat-activated encapsulation material at least substantially encapsulates a pharmaceutical product within pharmaceutical product packaging encompasses the heat-activated encapsulation material totally encapsulating a pharmaceutical product within pharmaceutical product packaging). Finally, a reference of a feature in conjunction with the phrase “in one embodiment” or the like does not limit the use of the feature to a single embodiment.

### BRIEF DESCRIPTION OF THE FIGURES

FIG. 1A is a top view of a representative blister card that may be utilized by each of the pharmaceutical product supplies of FIGS. 2-5.

FIG. 1B is a side view of the blister card of FIG. 1A.

FIG. 1C is an end view of the blister card of FIG. 1A.

FIG. 2 is a perspective view of a pharmaceutical product supply according to one embodiment, both before and after being heated to at least an activation temperature of a heat-activated encapsulation material of pharmaceutical product packaging of the pharmaceutical product supply.

FIG. 3 is a perspective view of a pharmaceutical product supply according to another embodiment, both before and after being heated to at least an activation temperature of a heat-activated encapsulation material of a sleeve of the pharmaceutical product supply.

FIG. 4 is a view of a pharmaceutical product supply according to another embodiment, with the pharmaceutical product supply being presented in a cutaway, perspective view, both before and after being heated to at least an activation temperature of a heat-activated encapsulation material of a container of the pharmaceutical product supply.

FIG. 5 is a view of a pharmaceutical product supply according to another embodiment, with the pharmaceutical product supply being presented in a cross-sectional view, both before and after being heated to at least an activation temperature of a heat-activated encapsulation material located adjacent a latching mechanism of a container of the pharmaceutical product supply.

FIG. 6 is a flow diagram of a method of disposing of pharmaceutical product, for instance using any of the pharmaceutical product supplies of FIGS. 2-5.

### DETAILED DESCRIPTION

Various embodiments of pharmaceutical product supplies will be described in relation to the accompanying figures. A “pharmaceutical product supply” may generally be considered to be pharmaceutical product contained within any type of packaging or container (e.g., primary packaging, secondary packaging). For instance, pharmaceutical product may be contained or packaged within primary packaging (e.g., a blister card), and this primary packaging may be contained or stored within secondary packaging (e.g., carton, container). Either pharmaceutical product being contained within primary packaging or being additionally contained within secondary packaging may be referred to as a “pharmaceutical product supply”.

In any case, these pharmaceutical product supplies are configured to store “pharmaceutical product” as described herein (e.g., in any appropriate form, in any appropriate dose, and of any appropriate type), and furthermore include one or more features to facilitate the disposal of pharmaceutical product (e.g., used or unused). In this regard, the following embodiments include at least one heat-activated encapsulation material that facilitates disposal of pharmaceutical product packaging having pharmaceutical product contained therein by rendering the packaging at least substantially “unopenable”. When heated to an activation temperature, the heat-activated encapsulation material may at least substantially encapsulate the pharmaceutical product within the pharmaceutical product packaging, come into contact with remaining pharmaceutical product within the pharmaceutical product packaging, and/or come into contact with a latching mechanism of a cover of a container or packaging containing pharmaceutical product. After a cooling period (e.g., a length of time that allows the pharmaceutical product supply to cool to a temperature below the activation temperature), the pharmaceutical product supply may be appropriately disposed of.

As used herein, the terms “unopenable,” “limit,” “inhibit,” “inaccessible” or the like and variations thereof are used in the sense of at least substantially limiting or inhibiting access to pharmaceutical product contained within pharmaceutical product packaging (e.g., primary packaging, secondary packaging) in the manner(s) traditionally used to gain access to pharmaceutical product within such packaging (e.g., pressing a tablet or pill out of a blister pack using one's fingers, disengaging a latching mechanism to gain access to the interior of a container). In this regard, the heat-activated encapsulation materials and arrangements associated therewith discussed herein may not necessarily limit or inhibit access to pharmaceutical product contained within pharmaceutical product packaging in the case of non-traditional access methods being used (e.g., via damaging the pharmaceutical product packaging).

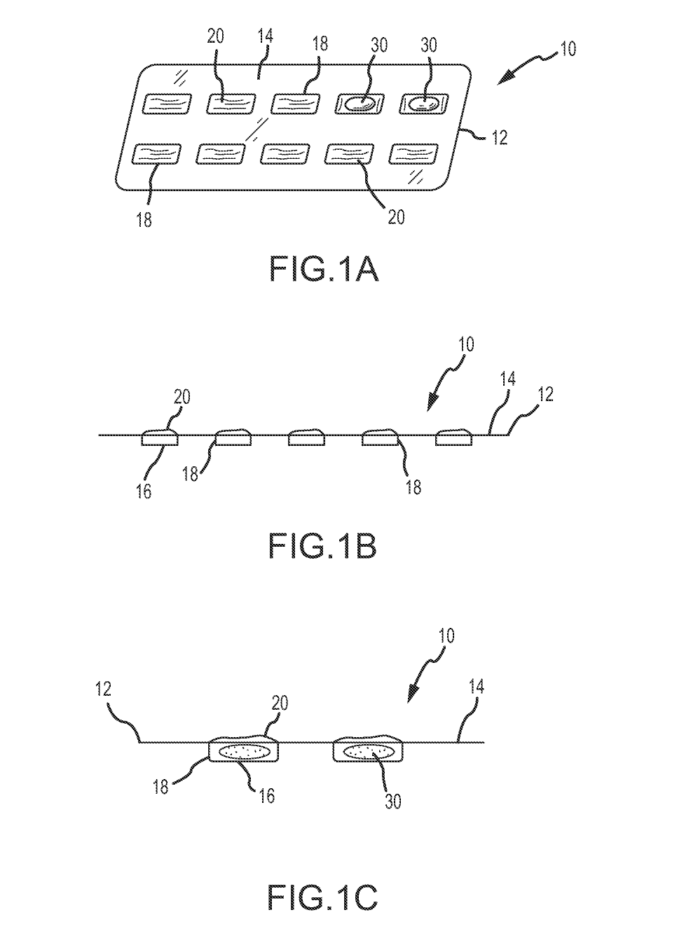

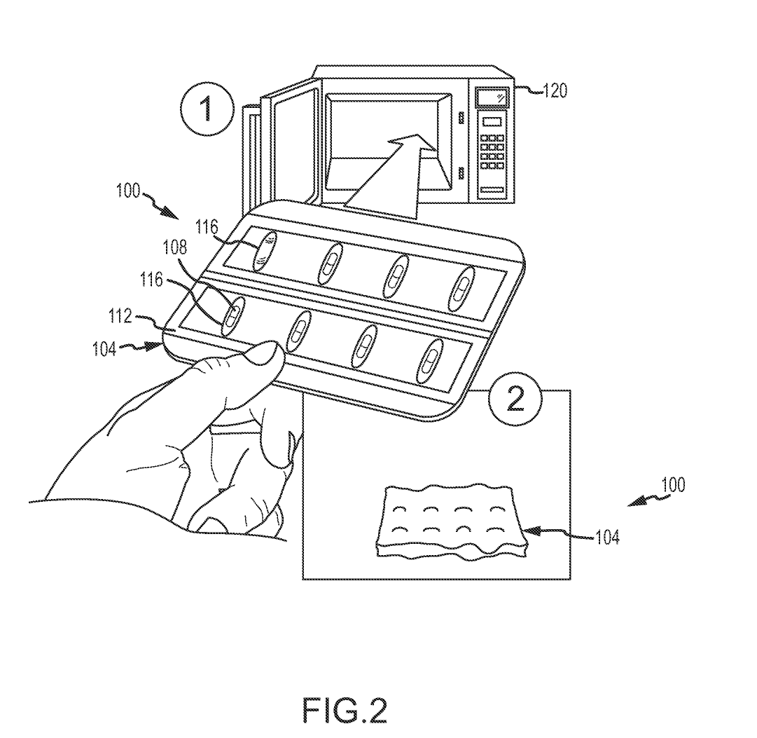

A representative blister card or pack is shown in FIGS. 1A, 1B, and 1C, is identified by reference numeral 10, and may be used in each of the embodiments of FIGS. 2-5 addressed below. The blister card 10 includes a tray 12 (e.g., a pre-formed structure, for instance plastic) having a plurality of receptacles 18. Any number of receptacles 18 may be utilized by the tray 12, and these receptacles 18 may be disposed in any appropriate arrangement. In the illustrated embodiment, there are two rows and five columns of receptacles 18. Any number of rows and columns may be utilized. Any arrangement of receptacles 18 may be utilized by the blister card 10.

Pharmaceutical product 30 may be disposed in each receptacle 18 of the blister card 10, and as such the blister card 10 may be referred to as “primary packaging” for the pharmaceutical product 30. A covering 20 is disposed over each receptacle 18 to enclose the corresponding pharmaceutical product 30 (the covering 20 being “puckered” in FIGS. 1B and 1C to distinguish the same from the tray 12, although the covering 20 could be at least substantially coplanar with the upper surface 14 of the tray 12). Although a single covering could extend over an entirety of an upper surface 14 of the tray 12 (or at least over each of the various receptacles 18), in the illustrated embodiment each receptacle 18 has its own individual covering 20. Any covering 20 for the blister card 10 may be in the form of a film, foil, paper, a sheet-like material, or the like. Generally, pharmaceutical product 30 may be removed from a given receptacle 18 by pushing on a lower surface 16 of the tray 12 (more specifically a receptacle 18), which in turn may push the pharmaceutical product 30 against the associated covering 20 with a sufficient force so as to rupture the covering 20. The covering 20 could also be “peeled” away from the tray 12 to gain access to pharmaceutical product 30 within a given receptacle 18. Any way of gaining access to the pharmaceutical product 30 in a given receptacle 18, enclosed by a covering 20, may be implemented by the blister card 10.

FIG. 2 presents a perspective view of a pharmaceutical product supply 100 according to one embodiment, both before and after being heated to at least an activation temperature of a heat-activated encapsulation material as will be described below. The pharmaceutical product supply 100 generally includes pharmaceutical product packaging in the form of primary packaging 104 (e.g., a blister card or blister pack; the blister card 10 of FIGS. 1A-C), and pharmaceutical product 108 (e.g., pills, tablets) contained within the primary packaging 104. The primary packaging 104 may be in direct contact with the pharmaceutical product 108 and may include a tray 112 including a plurality of formed receptacles or pockets 116, each of which may receive or hold at least one piece of pharmaceutical product 108. Additionally, the primary packaging 104 may include at least one covering (not shown, e.g., film, foil, paper, or the like) that is appropriately sealed or otherwise disposed over the tray 112 so as to contain the pharmaceutical product 108 within the pockets 116. That is, the covering may be sealed to a surface of the tray 112 that includes the pockets 116 such that the pharmaceutical product 108 may be generally contained between or enclosed by the tray 112 and the covering. In the absence of the heat-activated encapsulation material disclosed herein, a user may push or press a piece of pharmaceutical product 108 through the covering and/or peel off the covering to expose the pharmaceutical product 108. Although a single covering could cover each of the various receptacles 116, a separate covering could be provided for each of the individual receptacles 108. Pharmaceutical product 108 has been removed from one of the pockets 116 in FIG. 2. Pharmaceutical product 108 may have been removed from any appropriate number of the pockets 116 prior to configuring the primary packaging 104 for disposal in a manner that will now be described.

In this embodiment, at least some portion of the primary packaging 104 may be formed of a “heat-activated encapsulation material”. A “heat-activated encapsulation material” may be any appropriate material (e.g., low melting temperature materials, e.g., plastics) that is operable to, when heated to an “activation temperature” (i.e., a melting temperature of the heat-activated encapsulation material, e.g., in a microwave 120, near circled # 1 in FIG. 2), melt and/or subsequently flow onto or around pharmaceutical product 108, a portion of the primary packaging 104, a portion of secondary packaging (not shown), etc. The process of melting and flowing after being heated may be referred to as the heat-activated encapsulation material being “activated.” After a predetermined waiting or cooling period, whereby the heat-activated encapsulation material may be allowed to congeal, solidify or otherwise at least partially harden (i.e., the heat-activated encapsulation material cools to a temperature below the activation temperature), the pharmaceutical product 108 may be at least partially encased or encapsulated within or by the heat-activated encapsulation material so as to form a hardened “blob” of the pharmaceutical product 108 and the heat-activated encapsulation material (e.g., as shown near circled #2 in FIG. 2).

Activation of the heat-activated encapsulation material should reduce the potential of the pharmaceutical product 108 being administerable to an individual in the intended or traditional manner (e.g., where individual pharmaceutical products 108 are swallowed by a patient the pharmaceutical product 108 may now be limited or inhibited from being pressed through the covering of the primary packaging 104; pharmaceutical product 108 may be “locked” within the melted encapsulation material). It is also contemplated that as part of the process of heating the pharmaceutical product supply 100, properties (e.g., physical, chemical) of the pharmaceutical product 108 may be modified to render the pharmaceutical product 108 less potent or to otherwise make the pharmaceutical product 108 more difficult to administer. For instance, one or more active ingredients in the pharmaceutical product 108 may be neutralized as part of the heating process. In any case, the primary packaging 104 (with the pharmaceutical product 108 at least substantially encased thereinside) may now be disposed of in any appropriate manner (e.g., thrown in a trash receptacle).

The tray 112, the covering, or both the tray 112 and the covering of the pharmaceutical product supply 100 may be formed of the heat-activated encapsulation material. It should be noted that in some instances (e.g., when certain types of microwave ovens are used to heat the pharmaceutical product supply 100), an entirety of the pharmaceutical product supply 100 may be constructed to not include or be formed of metals or other materials that would tend to cause sparking or arcing during heating of the pharmaceutical product supply 100. In other instances (e.g., when the pharmaceutical product supply 100 is heated in a heating source capable of safely heating metals), the pharmaceutical product supply 100 may include one or more components constructed of metals (e.g., the covering being in the form of a foil).

In one arrangement, the pharmaceutical product supply 100 may additionally include secondary packaging (e.g., carton, box, not shown), and the primary packaging 104 may be disposed within the secondary packaging before the pharmaceutical product supply 100 is heated to the activation temperature of the heat-activated encapsulation material. In this regard, the secondary packaging would at least substantially retain the melted heat-activated encapsulation material, and the unit (i.e., the secondary packaging, the primary packaging 104, and the pharmaceutical product 108 within the primary packaging 104) can then be disposed of in any appropriate manner after the predetermined waiting/cooling period. The secondary packaging may be constructed of a material having a higher melting temperature than the melting or activation temperature of the heat-activated encapsulation material, or otherwise be at least partially structurally resistant to heating the pharmaceutical product supply 100 to the activation temperature of the heat-activated encapsulation material.

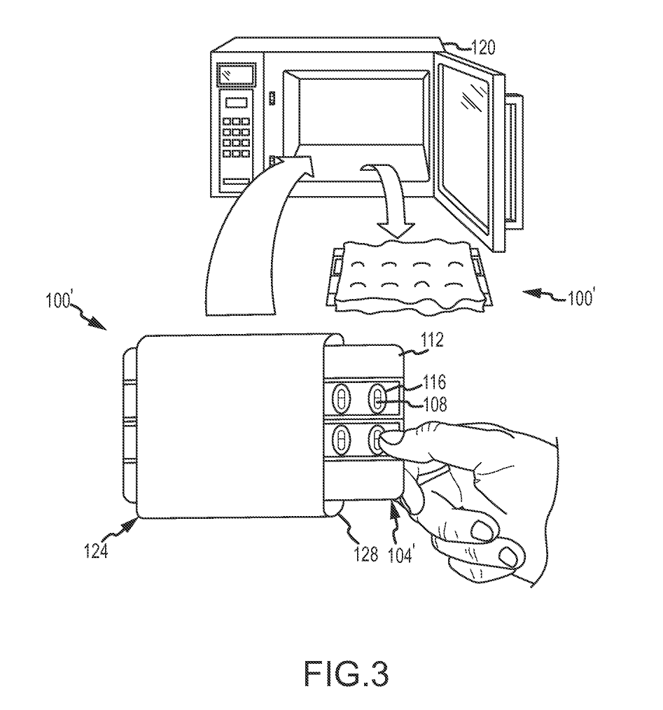

With reference now to FIG. 3, another embodiment of a pharmaceutical product supply 100′ incorporating a heat-activated encapsulation material is disclosed. Corresponding components between the embodiments of FIGS. 2 and 3 are identified by common reference numerals. Those corresponding components that differ in at least some respect from the embodiment of FIG. 2 are identified by a “single prime” designation in FIG. 3. As with the pharmaceutical product supply 100, the one or more components of the pharmaceutical product supply 100′ may be of any appropriate size, shape, configuration, and/or type. Two differences between the pharmaceutical product supply 100 of FIG. 2 and the pharmaceutical product supply 100′ of FIG. 3 are: a) the inclusion of a sleeve 124 being formed of a heat-activated encapsulation material into which the primary packaging 104′ may be inserted before the pharmaceutical product supply 100′ is heated to the activation temperature of the sleeve 124; and b) the primary packaging 104′ not necessarily needing to be at least partially formed of a heat-activated encapsulation material (although the primary packaging 104′ could incorporate a heat-activated encapsulation material in the manner discussed above in relation to the FIG. 2 embodiment).

The sleeve 124 may be formed or constructed at least partially from any appropriate previously discussed heat-activated encapsulation material, and may include an opening 128 into which the primary packaging 104′ may be inserted. The sleeve 124 may normally reside or be stored within secondary packaging (not shown, e.g., container, box, carton) of the pharmaceutical product supply 100′. The primary packaging 104′ may also be stored in this secondary packaging. When it is time to dispose of the pharmaceutical product 108, the sleeve 124 may be removed from the secondary packaging and slid over the primary packaging 104′ (i.e., the primary packaging 104′ may be inserted into the opening 128 of the sleeve 124). The pharmaceutical product supply 100′ may then be appropriately heated (e.g., in microwave 120) to at least the activation temperature of the sleeve 124 to allow the sleeve 124 to melt, and thereafter may be allowed to cool for a predetermined period of time (i.e., to a temperature below the activation temperature) to allow the sleeve 124 to shrink and/or congeal around the primary packaging 104′ and/or pharmaceutical product 108 to limit the pharmaceutical product 108 from being pushed through the covering and/or otherwise accessed (e.g., the primary packaging 104′ may be at least substantially unopenable, e.g., see pharmaceutical product supply 100′ closest to microwave 120 in FIG. 3). The pharmaceutical product supply 100′ may at this point be disposed of in any appropriate manner, for instance by being discarded into the trash. While not required, the sleeve 124 may be constructed and/or be of such dimensions so as to at least substantially cover all of the receptacles 116 when the primary packaging 104′ is inserted into the opening 128. This arrangement may limit the user from having to “line up” the sleeve 124 over only those receptacles 116 containing pharmaceutical product 108. That is, as long as an entirety of the tray 112 of the primary packaging 104′ is at least substantially covered or concealed by the sleeve 124, the user can heat the unit to the activation temperature with substantial confidence that at least substantially all of the pharmaceutical product 108 should eventually be encapsulated and thus rendered at least substantially inaccessible.

In one arrangement, the primary packaging 104′ may be disposed within the opening 128 of the sleeve 124, both of which may be disposed within the secondary packaging. The secondary packaging may then be heated to at least the activation temperature of the sleeve 124. As discussed in a previous embodiment, this arrangement may substantially retain the melted heat-activated encapsulation material before the pharmaceutical product supply 100′ is disposed of after the predetermined waiting/cooling period. Additionally, the primary packaging 104′ may no longer be able to be removed from the secondary packaging as the melted and subsequently solidified sleeve 124 may substantially rigidly interconnect the primary packaging 104′ to the secondary packaging. In another arrangement, the primary packaging 104′ may be inserted into the secondary packaging, and then the secondary packaging may be inserted into the opening 128 of the sleeve 124. That is, the sleeve 124 may be wrapped around both the primary packaging 104′ and secondary packaging. The secondary packaging may then be heated to at least the activation temperature of the sleeve 124 and then allowed to cool for a predetermined period of time and disposed of.

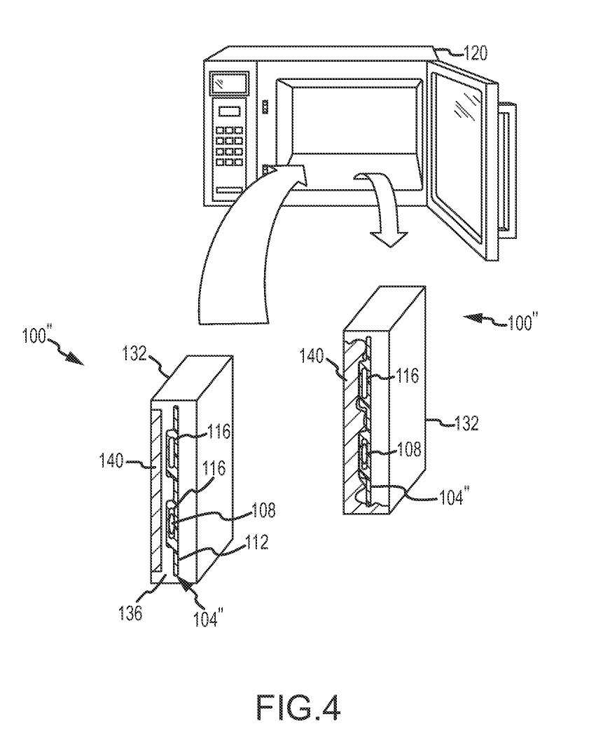

Turning now to FIG. 4, another embodiment of a pharmaceutical product container supply 100″ incorporating a heat-activated encapsulation material is disclosed. Corresponding components between the embodiments of FIGS. 2 and 4 are identified by common reference numerals. Those corresponding components that differ in at least some respect from the embodiment of FIG. 2 are identified by a “double prime” designation in FIG. 4. As with the pharmaceutical product supply 100, the one or more components of the pharmaceutical product supply 100″ may be of any appropriate size, shape, configuration, and/or type. Two differences between the pharmaceutical product supply 100 of FIG. 2 and the pharmaceutical product supply 100″ of FIG. 4 are: a) the inclusion of secondary packaging 132 (e.g., carton, box) including an interior cavity 136 into which the primary packaging 104″ can be disposed, and including a layer 140 (e.g., panel) of the previously discussed heat-activated encapsulation material within the cavity 136; and b) the primary packaging 104″ not needing to be at least partially formed of a heat-activated encapsulation material. Portions of the pharmaceutical product supply 100″ have been removed for viewing of an interior of the secondary packaging 132 in FIG. 4. Moreover, the layer 140 and the primary packaging 104″ are shown in cross-section for clarity.

The cavity 136 of the secondary packaging 132 may be sized to contain both the layer 140 and the primary packaging 104″. For instance, the layer 140 may be an integral part of the secondary packaging 132, such as an inside wall of the secondary packaging 132. Alternatively, the layer 140 may be a removable piece that may be separately inserted into the cavity 136. In one arrangement, the layer 140 may be applied or attached to the inside wall of the secondary packaging 132 via any appropriate attachment substances (e.g., adhesives). Additionally or alternatively, the inside wall of the secondary packaging 132 and/or the layer 140 may include gripping members (e.g., projections) protruding therefrom that are oriented and arranged to allow substantial one-way movement of the layer 140 relative to the cavity 136 (e.g., the layer 140 may be easily inserted into the cavity 136, but may be inhibited from being removed from the cavity 136 owing to the gripping members and/or adhesives). Moreover, the layer 140 may be disposed within the cavity 136 at any appropriate point(s) in the distribution process of the secondary packaging 132 (e.g., by the manufacturer, by the pharmacist, by the patient).

In any event, the primary packaging 104″ in the case of the pharmaceutical product supply 100″ of FIG. 4 may be inserted into the secondary packaging 132 when it is time to dispose of the pharmaceutical product 108, and the pharmaceutical product supply 100″ may then be appropriately heated (e.g., in microwave 120) to at least the activation temperature of the layer 140 to allow the layer 140 to melt, and thereafter may be allowed to cool for a predetermined period of time (i.e., to a temperature below the activation temperature) to allow the layer 140 to shrink and/or congeal around the primary packaging 104″ and/or pharmaceutical product 108. This may limit the pharmaceutical product 108 from being pushed through the covering of the primary packaging 104″ (e.g., the primary packaging 104″ may be unopenable), limit the primary packaging 104″ from being removed from the secondary packaging 132 due to the layer 140 at least substantially rigidly interconnecting the primary packaging 104″ to the secondary packaging 132, and/or limit the pharmaceutical product 108 from otherwise being accessed (e.g., see pharmaceutical product supply 100″ closest to microwave 120). The pharmaceutical product supply 100″ may at this point be disposed of in any appropriate manner, for instance by being discarded into the trash. While the heat-activated encapsulation material in this embodiment has been embodied in the form of layer 140, it is envisioned the heat-activated encapsulation material may alternatively or additionally be embodied in other forms (e.g., strips, blobs).

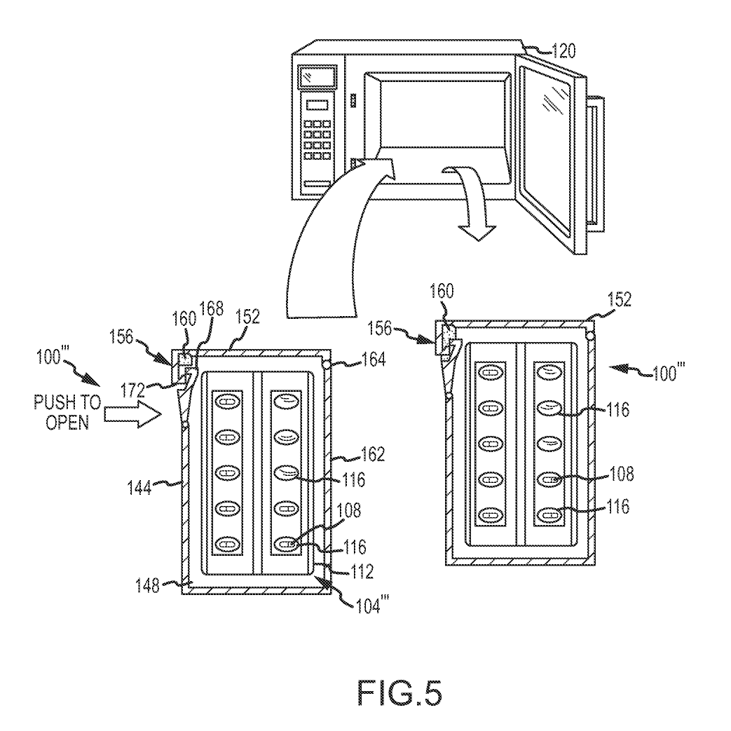

Turning now to FIG. 5, another embodiment of a pharmaceutical product container supply 100′″ incorporating a heat-activated encapsulation material is disclosed. Corresponding components between the embodiments of FIGS. 2 and 5 are identified by common reference numerals. Those corresponding components that differ in at least some respect from the embodiment of FIG. 2 are identified by a “triple prime” designation in FIG. 5. As with the pharmaceutical product supply 100, the one or more components of the pharmaceutical product supply 100′″ may be of any appropriate size, shape, configuration, and/or type. Differences between the pharmaceutical product supply 100 of FIG. 2 and the pharmaceutical product supply 100′″ of FIG. 5 are: a) secondary packaging 144 (e.g., container, carton, box) including an interior cavity 148, a cover 152 that selectively provides access to the interior cavity 148, a locking or latching mechanism 156 that is manipulable to open the cover 152, and at least one element 160 of the previously discussed heat-activated encapsulation material located adjacent or at least near the latching mechanism 156; and b) the primary packaging 104′″ not needing to be at least partially formed of a heat-activated encapsulation material (although the primary packaging 104′″ could incorporate a heat-activated encapsulation material in the manner discussed above in relation to the FIG. 2 embodiment).

As shown, the cover 152 may be pivotally interconnected to a body 162 of the secondary packaging 144 via any appropriate hinge or pivoting mechanism 164 to allow the cover 152 to selectively move between at least open and closed positions (i.e., before the element 160 is heated to its activation temperature). In another arrangement, the cover 152 may be rotationally interconnected (e.g., via a threaded connection) to the body 162 of the secondary packaging 144. In any case, the latching mechanism 156 functions to selectively allow the cover 152 to be at least partially separated from the body 162 to provide access to the interior cavity 148. Broadly, the latching mechanism 156 may include a first latching member 168 interconnected to the body 162 and a second latching member 172 interconnected to the cover 152 and that is operable to selectively engage with the first latching member 168 to restrict access to the interior cavity 148. The latching mechanism 156 may provide a level of child resistance to the secondary packaging 144. The latching mechanism 156 may be manipulated to separate the first and second latching members 168, 172 to allow the cover 152 to be at least partially separated from the body 162 in any appropriate manner (e.g., lifting the second latching member 172, depressing one or more buttons or levers in any appropriate order and/or arrangement).

As shown in the leftmost illustration of the pharmaceutical product supply 100′″ in FIG. 5, the element 160 of heat-activated encapsulation material may be disposed within or associated with the secondary packaging 144 adjacent and/or near the latching mechanism 156. In one variation, the latching mechanism 156 may be constructed of the element 160 of heat-activated encapsulation material. When it is time to dispose of the pharmaceutical product 108, the primary packaging 104′″ may be inserted into the interior cavity 148 of the secondary packaging 144 and the cover 152 may be closed (so as to restrict access into the interior cavity 148; to enclose the interior cavity 148) such that the first and second latching members 168, 172 engage. The pharmaceutical product supply 100′″ may then be appropriately heated (e.g., in microwave 120) to at least the activation temperature of the element 160 of heat-activated encapsulation material to allow the element 160 of heat-activated encapsulation material to melt and flow into spaces within and/or adjacent the latching mechanism 156 (as seen in the rightmost illustration of the pharmaceutical product supply 100′″ in FIG. 5). After the pharmaceutical product supply 100′″ has cooled for a predetermined period of time (i.e., to a temperature below the activation temperature), the element 160 of heat-activated encapsulation material may congeal or otherwise harden within and/or about the latching mechanism 156 to limit the latching mechanism 156 from being effectively operated (e.g., limit the first and second latching mechanisms 168, 172 from being separated from each other such that they are at least substantially non-removably interconnected). Thus, the cover 152 may be restricted from being moved to an open position (e.g., the secondary packaging 144 may be unopenable) and access to the primary packaging 104′″ (and pharmaceutical product 108 within the primary packaging 104′″) may be inhibited. The pharmaceutical product supply 100′″ may at this point be disposed of in any appropriate manner, for instance by being discarded into the trash.

As components or features of the pharmaceutical product supplies 100′,100″,100′″ other than the primary packaging 104′,104″,104′″ are constructed of or at least partially include a heat-activated encapsulation material, the primary packaging 104′, 104″, 104′″ need not necessarily (although they may) be constructed of a heat-activated encapsulation material. These embodiments may, for instance, be useful with pharmaceutical product 108 that requires that the primary packaging 104′, 104″, 104′″ be constructed of specific materials that are not heat-activated encapsulation materials as disclosed herein (e.g., to pass stability testing). Additionally, at least some portions of the secondary packaging may be constructed of materials that are able to structurally withstand (e.g., that do not melt) the activation temperature of the heat-activated encapsulation material.

It should be appreciated that any features of any of the embodiments and arrangements may be used in conjunction with any of the other embodiments and arrangements. As merely one example, the primary packaging 104′″ of FIG. 5 could be constructed at least partially of a heat-activated encapsulation material which would melt and congeal around the pharmaceutical product 108 upon the pharmaceutical product supply 100′″ being heated to at least the activation temperature of the heat-activated encapsulation material. In this regard, even if one was able to somehow access the interior cavity 148 of the secondary packaging 144, the pharmaceutical product would still be at least substantially encased within the primary packaging 104′″. As another example, the sleeve 124 of FIG. 3 could be used in conjunction with the pharmaceutical product supplies 100″, 100′″ of FIGS. 4 and 5. In a further arrangement, it is contemplated that the pharmaceutical product supplies 100, 100′, 100″, 100′″ may include multiple types of heat-activated encapsulation materials, at least two of which have different activation materials. This may be useful when it is desired that, upon heating the pharmaceutical product supplies 100, 100′, 100″, 100′″, the heat-activated encapsulation component of one portion of the pharmaceutical product supplies 100, 100′, 100″, 100′″ is activated (e.g., melts) while that of another portion does not. At a later point in time, a user may again heat the pharmaceutical product supplies 100, 100′, 100″, 100′″ to the activation temperature of the not yet melted heat-activated encapsulation material to melt this material and allow it to melt and encapsulate primary packaging, pharmaceutical product, latching mechanisms, or the like. Other arrangements are also envisioned.

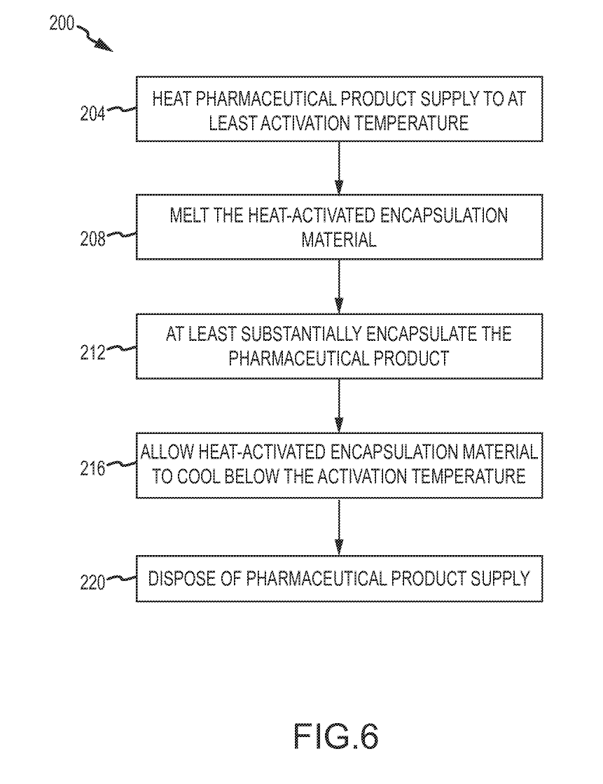

Turning now to FIG. 6, one method 200 for disposing of unused pharmaceutical product (e.g., using any of the pharmaceutical product supplies disclosed herein) is illustrated, although it will be appreciated that numerous other methods of using the pharmaceutical product supplies disclosed herein are contemplated. In step 204, any of the pharmaceutical product supplies disclosed herein (including one or more pharmaceutical products) may be appropriately heated (e.g., by or within a heating source) to at least the activation temperature (e.g., the melting temperature of the heat-activated encapsulation material). For instance, step 204 may include positioning the pharmaceutical product supplies into a microwave oven and operating the microwave oven on a particular power level for a particular amount of time to achieve the activation temperature. It should be appreciated that the amount of time the pharmaceutical product supplies are heated may be less than that necessary to melt or otherwise destroy or degrade those features or components of the pharmaceutical product supplies that are not intended to be destroyed or melted. Additionally, the packaging (e.g., primary packaging) containing the pharmaceutical product may first be disposed into secondary packaging (e.g., a container) and then a latching mechanism may be activated. It should also be appreciated that these steps may depend upon voluntary participation by a user. That is, the pharmaceutical products may not be rendered unusable and thus the user may freely access the pharmaceutical products until the user chooses to heat the pharmaceutical product supplies to at least the activation temperature.

In any event, the heat-activated encapsulation material may be allowed to melt in step 208 so as to drip or flow and contact one or more of the pharmaceutical product, primary packaging, secondary packaging, etc. as discussed previously. Once the heat-activated encapsulation material has melted, it may encapsulate or contact the pharmaceutical product and/or the latching mechanism of the secondary packaging in step 212. This may include essentially locking the pharmaceutical product within the packaging by the heat-activated encapsulation material contacting the packaging. The heat-activated encapsulation material may then harden or solidify in step 216 after the heat-activated encapsulation material has been allow to cool to a temperature below the activation temperature. The pharmaceutical product supply or supplies may then be disposed of in step 220 (e.g., in any appropriate trash receptacle).

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such or other embodiments and with various modifications required by the particular application(s) or use(s) of the present invention. It is intended that the appended claims be construed to include alternative embodiments to the extent permitted by the prior art.

What is claimed:

1. A method of disposing pharmaceutical product, comprising:
heating pharmaceutical product packaging, wherein said pharmaceutical product packaging comprises a plurality of receptacles and an encapsulation material, wherein unused pharmaceutical product is enclosed within at least one of said plurality of receptacles by said pharmaceutical product packaging prior to said heating, wherein said heating is to at least an activation temperature of said encapsulation material, and wherein said heating comprises melting said encapsulation material and flowing said encapsulation material onto said each said unused pharmaceutical product within said pharmaceutical product packaging; and
cooling said encapsulation material after said heating to lock said unused pharmaceutical product within said encapsulation material to at least substantially encapsulate said unused pharmaceutical product within said pharmaceutical product packaging.

2. The method of claim 1, wherein said pharmaceutical product packaging contacts said pharmaceutical product prior to said heating.

3. The method of claim 1, wherein said pharmaceutical product packaging comprises primary packaging.

4. The method of claim 3, wherein said primary packaging comprises a tray and a covering that is sealed to said tray, wherein said tray comprises said plurality of receptacles, and wherein said heating is initiated with said cover already having been sealed to said tray.

5. The method of claim 4, wherein said tray comprises a formed plastic tray.

6. The method of claim 4, wherein said covering is selected from the group consisting of a film, a foil, paper, and any combination thereof.

7. The method of claim 6, wherein said covering is non-metallic.

8. The method of claim 4, wherein said covering is sealed to a surface of said tray that comprises said plurality of receptacles.

9. The method of claim 4, wherein at least one of said tray and said covering comprises said heat-activated encapsulation material.

10. The method of claim 9, wherein said tray comprises said heat-activated encapsulation material.

11. The method of claim 1, wherein an entirety of said pharmaceutical product packaging is non-metallic.

12. The method of claim 1, wherein said pharmaceutical product packaging comprises a blister card.

13. The method of claim 1, further comprising:
positioning said pharmaceutical product packaging in a container prior to said heating, wherein said heating is executed with said pharmaceutical product packaging being in said container.

14. The method of claim 13, wherein said pharmaceutical product packaging comprises primary packaging and wherein said container comprises secondary packaging.

15. The method of claim 1, further comprising:
configuring said pharmaceutical product packaging for disposal, wherein said configuring comprises said heating and said cooling.

16. The method of claim 15, further comprising:
disposing said pharmaceutical product packaging after said heating and said cooling.

17. The method of claim 1, further comprising:
disposing said pharmaceutical product packaging after said heating and said cooling.
